(19) United States
(12) Patent Application Publication
(10) Pub. No.: US 2023/0420728 A1
(43) Pub. Date: Dec. 28, 2023

(54) SOLID-STATE ELECTROLYTE BATTERY INCLUDING PLASTIC CRYSTAL ELECTROLYTE INTERLAYER

(71) Applicant: Giner, Inc., Newton, MA (US)

(72) Inventors: Hui Xu, Acton, MA (US); Pavithra M. Shanthi, Natick, MA (US)

(21) Appl. No.: 18/210,411

(22) Filed: Jun. 15, 2023

Related U.S. Application Data
(60) Provisional application No. 63/352,537, filed on Jun. 15, 2022.

(51) Int. Cl. H01M 10/056; H01M 10/0585; H01M 50/414; H01M 50/434; H01M 50/446; H01M 50/457; H01M 50/489

(52) U.S. Cl. CPC H01M 10/056; H01M 10/0585; H01M 50/414; H01M 50/434; H01M 50/446; H01M 50/457; H01M 50/489; H01M 2300/0091; H01M 2300/0082; H01M 2300/0071; H01M 2300/008; H01M 2300/0094

(57) ABSTRACT

Solid-state electrolyte battery and method for making same. In one embodiment, the solid-state electrolyte battery may include an anode, a cathode, and a solid-state electrolyte membrane, wherein the solid-state electrolyte membrane may be positioned between the anode and the cathode. The solid-state electrolyte membrane may be in the form of a layer having opposing surfaces. The solid-state electrolyte battery may further include a first plastic crystal electrolyte layer and a second plastic crystal electrolyte layer, wherein the first and second plastic crystal electrolyte layers may be similar to one another in structure and composition. At least a portion of the first plastic crystal electrolyte layer may be positioned between the anode and the first opposing surface of the solid-state electrolyte membrane. At least a portion of the second plastic crystal electrolyte layer may be positioned between the cathode and the second opposing surface of the solid-state electrolyte membrane.

### CROSS-REFERENCE TO RELATED APPLICATIONS

The present application claims the benefit under 35 U.S.C. 119(e) of U.S. Provisional Patent Application No. 63/352,537, inventors Hui Xu et al., filed Jun. 15, 2022, the disclosure of which is incorporated herein by reference.

### FEDERALLY SPONSORED RESEARCH OR DEVELOPMENT

This invention was made with government support under DE-SC0002360, awarded by the Department of Energy, Small Business Innovation Research and Small Business Technology Transfer (SBIR/STTR) Programs Office. The government has certain rights in the invention.

### BACKGROUND OF THE INVENTION

The present invention relates generally to solid-state electrolyte batteries and relates more particularly to a novel solid-state electrolyte battery.

Lithium-ion (Li-ion) batteries have been widely used in a variety of applications including deployment in electric vehicles (EVs). Typically, lithium-ion batteries use lithium salts dissolved in organic solvents, such as carbonates, as the electrolyte. Unfortunately, lithium-ion batteries that use these electrolytes pose several severe problems that limit their further development and use. These problems include organic solvent-associated corrosion, leakage, volatility, and flammability. There have been many attempts to replace the flammable liquid component of the electrolyte with alternative alkali metal transporting media, such as superionic crystals, alkali-conducting glassy solids, ionic liquids, salt-in-molecular plastic crystal solvent, and salt-in-ionic plastic crystal solvents.

However, many of these garnet or glass electrolytes, which are rigid materials, tend to be mechanically fragile and encounter interfacial problems with the anode and cathode materials of the battery. Making these electrolyte materials into mechanically flexible thin membranes has been difficult; furthermore, making a thin film of solid electrolytes that simultaneously retains high ionic conductivity and mechanical resiliency in a cost-effective approach is extremely challenging. Currently, solid electrolytes are typically made by chemical and thermal vapor deposition, radio frequency sputtering and pulsed laser deposition. These processes require expensive facilities, substantial time, and are difficult to scale-up for mass production. Moreover, the thin film made from inorganic powders is brittle and does not provide mechanical flexibility, making membrane handling, and shaping and cell assembly extremely difficult.

Furthermore, synthesizing electrolytes with high conductivity is not the only factor used in achieving high cell performance; instead, it has become more important to reduce the electrode/solid electrolyte interfacial resistance by making mechanically resilient thin-film solid electrolytes that are also economically viable and scalable.

### SUMMARY OF THE INVENTION

It is an object of the present invention to provide a novel solid-state electrolyte battery.

It is another object of the present invention to provide a solid-state electrolyte battery as described above that overcomes at least some of the shortcomings associated with at least some existing solid-state electrolyte batteries.

It is still another object of the present invention to provide a solid-state electrolyte battery as described above that is easy to manufacture and easy to use.

Therefore, according to one aspect of the invention, there is provided a solid-state electrolyte battery, the solid-state electrolyte battery comprising (a) an anode; (b) a cathode; (c) a solid-state electrolyte membrane, the solid-state electrolyte membrane positioned between and operatively coupled to the anode and the cathode, wherein the solid-state electrolyte membrane is spaced away from at least one of the anode and the cathode; and (d) a first plastic crystal electrolyte interlayer, at least a portion of the first plastic crystal electrolyte interlayer being positioned between the solid-state electrolyte membrane and one of the anode and the cathode.

In a more detailed feature of the invention, the solid-state electrolyte membrane may be spaced away from each of the anode and the cathode, at least a portion of the first plastic crystal electrolyte interlayer may be positioned between the solid-state electrolyte membrane and the anode, the solid-state electrolyte battery may further comprise a second plastic crystal electrolyte interlayer, and at least a portion of the second plastic crystal electrolyte interlayer may be positioned between the solid-state electrolyte membrane and the cathode.

In a more detailed feature of the invention, the first plastic crystal electrolyte interlayer may be in direct contact with each of the anode and the solid-state electrolyte membrane, and the second plastic crystal electrolyte interlayer may be in direct contact with each of the cathode and the solid-state electrolyte membrane.

In a more detailed feature of the invention, each of the first plastic crystal electrolyte interlayer and the second plastic crystal electrolyte interlayer may have a thickness in a range of about 100 nanometers to about 100 microns.

In a more detailed feature of the invention, the solid-state electrolyte membrane may have a thickness in a range of about 100 microns to about 1 millimeter.

In a more detailed feature of the invention, the solid-state electrolyte membrane may comprise a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight.

In a more detailed feature of the invention, the solid-state electrolyte membrane may comprise a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

In a more detailed feature of the invention, the first plastic crystal electrolyte interlayer may comprise a plastic crystal electrolyte of the formula SiX₃SO₄Li wherein X may a hydrocarbon moiety.

In a more detailed feature of the invention, the first plastic crystal electrolyte interlayer may comprise lithium trimethylsilylsulfate.

In a more detailed feature of the invention, the first plastic crystal electrolyte interlayer may comprise an inorganic salt that demonstrates plastic crystal behavior at high temperatures.

In a more detailed feature of the invention, the inorganic salt may be Li₂SO₄.

In a more detailed feature of the invention, the first plastic crystal electrolyte interlayer may comprise a molecular species that allows good ionic conductivity by the addition of a lithium salt.

In a more detailed feature of the invention, the molecular species may be succinonitrile.

In a more detailed feature of the invention, the first plastic crystal electrolyte interlayer may comprise an organic ionic plastic crystal.

In a more detailed feature of the invention, the organic ionic plastic crystal may be at least one member of the group of pyrrolidinium; tetramethylammonium; imidazaolium; alkyl sulfoniums; 1-ethyl-1,4-diazabicyclo[2.2.2] octane; alkylene bis [N—(N′-alkylimidazolium)] salts; bis(fluorosulfonyl)amide; cyanate; choline; dihydrogen phosphate; dicyanomethanide; Li[B(OCH₂CH₂OCH₃)₄]; dicyanamide; and bis(trifluoromethyl sulfonyl)amide.

In a more detailed feature of the invention, each of the first plastic crystal electrolyte interlayer and the second plastic crystal electrolyte interlayer may have a thickness in a range of about 100 nm to about 100 microns, the solid-state electrolyte membrane may have a thickness in a range of about 100 microns to about 1 millimeter, the solid-state electrolyte membrane may comprise a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight, and each of the first plastic crystal electrolyte interlayer and the second plastic crystal electrolyte interlayer may comprise lithium trimethylsilylsulfate.

In a more detailed feature of the invention, the solid-state electrolyte membrane may comprise a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

According to another aspect of the invention, there is provided a solid-state electrolyte battery, the solid-state electrolyte battery comprising (a) an anode; (b) a cathode; (c) a solid-state electrolyte membrane, the solid-state electrolyte membrane positioned between and operatively coupled to the anode and the cathode, the solid-state electrolyte membrane having first and second opposed surfaces; and (d) a first plastic crystal electrolyte, the first plastic crystal electrolyte being disposed at at least one of the first and second opposed surfaces of the solid-state electrolyte membrane.

In a more detailed feature of the invention, the first plastic crystal electrolyte may be disposed at the first opposed surface of the solid-state electrolyte membrane, the solid-state electrolyte battery may further comprise a second plastic crystal electrolyte, and at least a portion of the second plastic crystal electrolyte may be disposed at the second opposed surface of the solid-state electrolyte membrane.

In a more detailed feature of the invention, the first plastic crystal electrolyte may be in direct contact with each of the anode and the solid-state electrolyte membrane, and the second plastic crystal electrolyte may be in direct contact with each of the cathode and the solid-state electrolyte membrane.

In a more detailed feature of the invention, each of the first plastic crystal electrolyte and the second plastic crystal electrolyte may have a thickness in a range of about 100 nm to about 100 microns.

In a more detailed feature of the invention, the solid-state electrolyte membrane may have a thickness in a range of about 100 microns to about 1 millimeter.

In a more detailed feature of the invention, the solid-state electrolyte membrane may comprise a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight.

In a more detailed feature of the invention, the solid-state electrolyte membrane may comprise a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

In a more detailed feature of the invention, the first plastic crystal electrolyte interlayer may comprise a plastic crystal electrolyte of the formula SiX₃SO₄Li wherein X may be a hydrocarbon moiety.

In a more detailed feature of the invention, the first plastic crystal electrolyte interlayer may comprise lithium trimethylsilylsulfate.

According to yet another aspect of the invention, there is provided a solid-state electrolyte membrane suitable for use in a solid-state electrolyte battery, the solid-state electrolyte membrane comprising a mixture of (a) polyethylene oxide in an amount constituting by weight; (b) lithium lanthanum zirconium oxide in an amount constituting 10-40% by weight; and (c) lithium trifluoromethane sulfonimide in an amount constituting 10-40% by weight.

In a more detailed feature of the invention, the polyethylene oxide may constitute about 65% by weight, the lithium lanthanum zirconium oxide may constitute about 20% by weight, and the lithium trifluoromethane sulfonimide may constitute about 15% by weight.

According to still another aspect of the invention, there is provided a solid-state electrolyte battery, the solid-state electrolyte battery comprising (a) an anode; (b) a cathode; and (c) the above-described solid-state electrolyte membrane, the solid-state electrolyte membrane positioned between and operatively coupled to the anode and the cathode.

In a more detailed feature of the invention, the solid-state electrolyte battery may further comprise a first plastic crystal electrolyte interlayer interfacing the solid-state electrolyte and the anode and a second plastic crystal electrolyte interlayer interfacing the solid-state electrolyte and the cathode.

In a more detailed feature of the invention, each of the first plastic crystal electrolyte interlayer and the second plastic crystal electrolyte interlayer may comprise lithium trimethylsilylsulfate.

In a more detailed feature of the invention, the anode may be a lithium metal anode, and the cathode may be a lithium nickel manganese cobalt oxide cathode.

In a more detailed feature of the invention, each of the first plastic crystal electrolyte and the second plastic crystal electrolyte may have a thickness in a range of about 100 nm to about 100 microns, and the solid-state electrolyte membrane may have a thickness in a range of about 100 microns to about 1 millimeter.

The present invention is also directed at methods of making the above-described plastic crystal interlayer and a solid-state electrolyte battery comprising the same.

For purposes of the present specification and claims, various relational terms like “top,” “bottom,” “proximal,” “distal,” “upper,” “lower,” “front,” and “rear” may be used to describe the present invention when said invention is positioned in or viewed from a given orientation. It is to be understood that, by altering the orientation of the invention, certain relational terms may need to be adjusted accordingly.

Additional objects, as well as aspects, features, and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. The drawings are not necessarily drawing to scale, and certain components may have undersized and/or oversized dimensions for purposes of explication. In the drawings wherein like reference numeral represents like parts:

FIG. 1 is a simplified schematic side view of one embodiment of a solid-state electrolyte battery constructed according to the present invention;

FIG. 2A is a graph depicting the results from Li/Li⁺ symmetrical cell plating on a solid-state electrolyte membrane with plastic crystal electrolyte coated on one side of the solid-state electrolyte membrane, as discussed in Example 1;

FIG. 2B is a graph depicting the results of full cell cyclic voltammetry on a solid-state electrolyte membrane with plastic crystal electrolyte coated on both sides of the solid-state electrolyte membrane, as discussed in Example 1;

FIG. 3A is a graph depicting the discharge capacity of various solid-state electrolyte membranes with and without a plastic crystal electrolyte, as discussed in Example 2;

FIG. 3B is a graph depicting charge-discharge profiles of full cells assembled with solid-state electrolyte membranes with and without a plastic crystal electrolyte, as discussed in Example 2;

FIG. 4A is a graph depicting the C-rate performance of the solid-state electrolyte membrane/plastic crystal electrolyte combination, as discussed in Example 2; and

FIG. 4B is a graph depicting the loading performance of the solid-state electrolyte membrane/plastic crystal electrolyte combination, as discussed in Example 2.

### DETAILED DESCRIPTION OF THE INVENTION

The present invention is directed, at least in part, at a novel solid-state electrolyte battery and at a novel method for the fabrication thereof. According to one aspect of the invention, the solid-state electrolyte battery may comprise, in at least one or more embodiments, a novel solid-state electrolyte membrane. According to another aspect of the invention, the solid-state electrolyte battery may comprise, in at least one or more embodiments, a plastic crystal electrolyte. In at least some embodiments, the plastic crystal electrolyte is in the form of a layer, at least a portion of which is positioned between the solid-state electrolyte membrane and at least one of the battery electrodes. More specifically, in at least some embodiments, the solid-state electrolyte battery may comprise a first plastic crystal electrolyte interlayer and a second plastic crystal electrolyte interlayer, wherein at least a portion of the first plastic crystal electrolyte interlayer may be positioned between, and in direct contact with, the solid-state electrolyte and the anode, and wherein at least a portion of the second plastic crystal electrolyte interlayer may be positioned between, and in direct contact with, the solid-state electrolyte and the cathode.

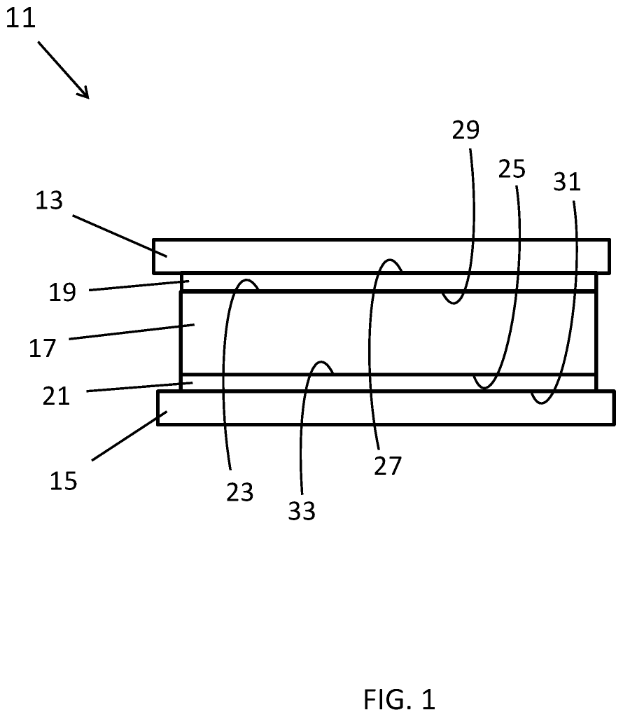

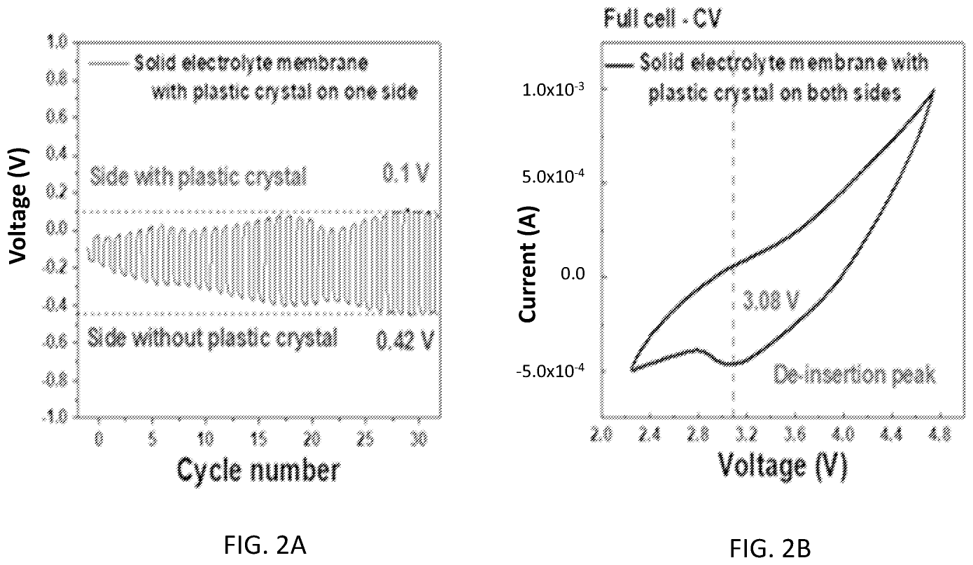

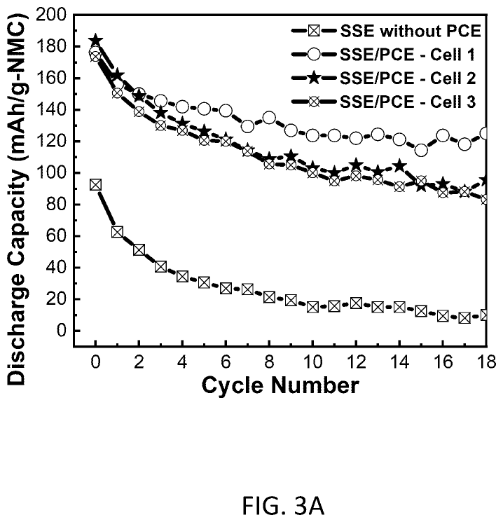

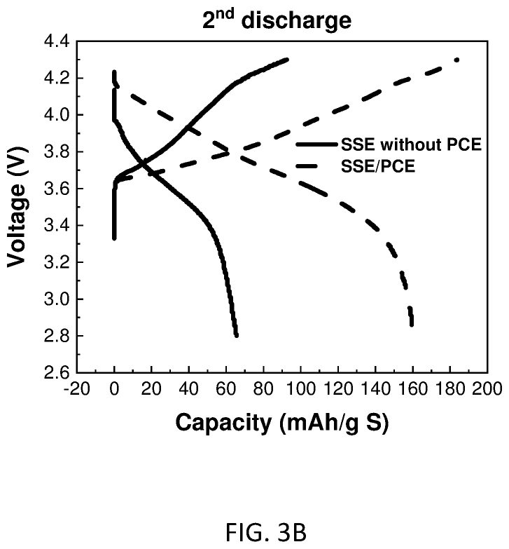

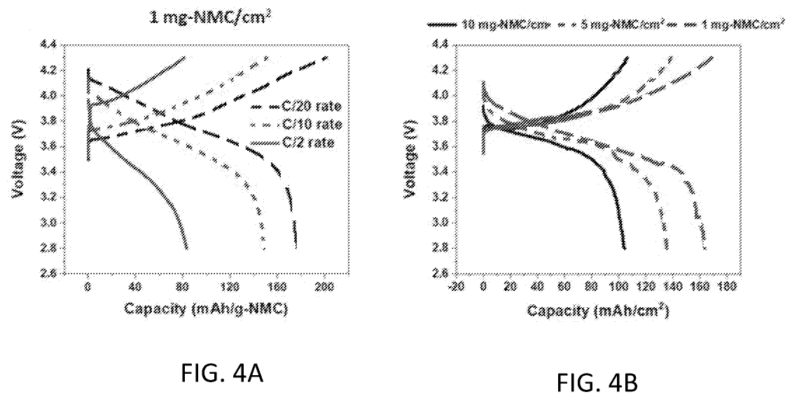

Referring now to FIG. 1, there is shown a simplified side view of one embodiment of a solid-state electrolyte battery constructed according to the present invention, the solid-state electrolyte battery being represented generally by reference numeral 11. Details of solid-state electrolyte battery 11 that are discussed elsewhere in this application or that are not critical to an understanding of the invention may be omitted from FIG. 1 and/or from the accompanying description herein or may be shown in FIG. 1 and/or described herein in a simplified manner.

Solid-state electrolyte battery 11 may comprise an anode 13, a cathode 15, a solid-state electrolyte membrane 17, a first plastic crystal electrolyte interlayer 19, and a second plastic crystal electrolyte interlayer 21.

Anode 13 may be similar in size, shape and composition to any anode, whether conventional or otherwise, of the type suitable for use in a lithium-ion battery or solid-state electrolyte battery. For example, anode 13 may be a lithium metal anode, a graphitic anode, or a titanium-based anode. In the present embodiment, anode 13 may have a generally rectangular prismatic shape.

Cathode 15 may be similar in size, shape and composition to any cathode, whether conventional or otherwise, of the type suitable for use in a lithium-ion battery or solid-state electrolyte battery. For example, cathode 15 may be a lithium nickel manganese cobalt oxide (NMC) cathode, preferably an 811 NMC (80% Ni, 10% Mn, 10% Co) cathode. In the present embodiment, cathode 15 may have a generally rectangular prismatic shape.

Solid-state electrolyte membrane 17 may be similar in size, shape and composition to any solid-state electrolyte membrane, whether conventional or otherwise, of the type suitable for use in a solid-state electrolyte battery. Notwithstanding the above, in a preferred embodiment, solid-state electrolyte membrane 17 may consist of or comprise a mixture of the following type: (i) a polymer, which may be polyethylene oxide (PEO) in an amount constituting 50-90% by weight; (ii) a ceramic solid electrolyte, which may be lithium lanthanum zirconium oxide (LLZO) in an amount constituting 10-40% by weight; and (iii) a lithium ion conductor, which may be lithium trifluoromethane sulfonimide (Litfsi) in an amount constituting 10-40% by weight. Based on desired material properties, such as room temperature lithium-ion conductivity and mechanical robustness, a particularly preferred composition for use as solid-state electrolyte membrane 17 may consist of the following: (i) 65 wt % PEO; (ii) 20 wt % LLZO; and (iii) 15 wt % Litfsi. In the present embodiment, solid-state electrolyte membrane 17 may have a generally rectangular prismatic shape with a generally planar first side 23 facing towards anode 13 and a generally planar second side 25 facing towards cathode 15. Solid-state electrolyte membrane 17 may have a thickness in a range of about 100 microns to about 1 mm.

First plastic crystal electrolyte interlayer 19 and second plastic crystal electrolyte interlayer 21 may be similar to one another in size, shape and composition. In the present embodiment, first and second plastic crystal electrolyte interlayers 19 and 21 are preferably identical to one another; nevertheless, it is to be understood that first and second plastic crystal electrolyte interlayers 19 and 21 may differ from one another in one or more of size, shape and composition. That being said, first and second plastic crystal electrolyte interlayers 19 and 21 are preferably compatible with one another in case they come into contact with one another, for example, by seeping through solid-state electrolyte membrane 17.

First plastic crystal electrolyte interlayer 19 may serve as an interface between solid-state electrolyte membrane 17 and anode 13, and second plastic crystal electrolyte interlayer 21 may serve as an interface between solid-state electrolyte membrane 17 and cathode 15. In the present embodiment, solid-state electrolyte membrane 17 may be spaced apart from anode 13, and first plastic crystal electrolyte interlayer 19 may couple together solid-state electrolyte membrane 17 and anode 13 in a manner that improves ion conduction therebetween (i.e., reduces interfacial resistance between solid-state electrolyte membrane 17 and anode 13). In a similar vein, in the present embodiment, solid-state electrolyte membrane 17 may be spaced apart from cathode 15, and second plastic crystal electrolyte interlayer 21 may couple together solid-state electrolyte membrane 17 and cathode 15 in a manner that improves ion conduction therebetween (i.e., reduces interfacial resistance between solid-state electrolyte membrane 17 and cathode 15). To this end, in the present embodiment, first plastic crystal electrolyte interlayer 19 may have a generally rectangular prismatic shape with first and second opposing surfaces 27 and 29. First opposing surface 27 of first plastic crystal electrolyte interlayer 19 may be in direct contact with anode 13, and second opposing surface 29 of first plastic crystal electrolyte interlayer 19 may be in direct contact with surface 23 of solid-state electrolyte membrane 17 (or, if first plastic crystal electrolyte interlayer 19 penetrates, to some degree, solid-state electrolyte membrane 17, second opposing surface 29 may be disposed within solid-state electrolyte membrane 17 interior to surface 23 of solid-state electrolyte membrane 17). In a similar manner, second plastic crystal electrolyte interlayer 21 may have a generally rectangular prismatic shape with first and second opposing surfaces 31 and 33. First opposing surface 31 of second plastic crystal electrolyte interlayer 21 may be in direct contact with cathode 15, and second opposing surface 33 of second plastic crystal electrolyte interlayer 21 may be in direct contact with surface 25 of solid-state electrolyte membrane 17 (or, if second plastic crystal electrolyte interlayer 21 penetrates, to some degree, solid-state electrolyte membrane 17, second opposing surface 33 may be disposed within solid-state electrolyte membrane 17 interior to surface 25 of solid-state electrolyte membrane 17).

Each of first plastic crystal electrolyte interlayer 19 and second plastic crystal electrolyte interlayer 21 may have a thickness in a range from about 100 nm to about 100 microns.

Each of first plastic crystal electrolyte interlayer 19 and second plastic crystal electrolyte interlayer 21 may consist or comprise one or more lithiated plastic crystal electrolytes. Plastic crystal electrolytes are a class of superionic solid electrolytes with remarkable ion conductivity and mechanical resilience. Plastic crystals are orientationally disordered crystals, a material that lies in between ordered crystals and amorphous structures. Plastic crystal electrolytes are soft and buttery materials. Plastic crystal electrolytes provide high ionic conductivity while eliminating the challenges associated with more traditional solvents, such as flammability, instability/incompatibility between electrodes and electrolyte, changes in volume of electrolyte, and leakage.

Virtually any lithiated plastic crystal electrolyte may be used to form first and second plastic crystal electrolyte interlayers 19 and 21. For example, materials suitable for use as first plastic crystal electrolyte interlayer 19 and second plastic crystal electrolyte interlayer 21 may include lithiated plastic crystal electrolytes of the type disclosed in Klein et al., “A New Version of the Lithium Ion Conducting Plastic Crystal Solid Electrolyte,” Advanced Energy Materials, 8:1801324 (2018), which is incorporated herein by reference. Such lithiated plastic crystal electrolytes can be produced as soft deformable solids by the solid-state neutralization of mono hydrogensulphate solid acids of —SiX₃, using anhydrous lithium amide, according to the following equation (Equation 1):

SiX₃SO₄H(s)+LiNH₂₍ₛ₎→SiX₃SO₄Li₍ₛ₎+NH_{3(g)} (1)

where the silicon ligands X, which may be hydrocarbons (e.g., one or more —CH₃ groups, one or more —CH₂ groups, one or more —CH groups, and combinations thereof) can be as many as there are polyphenylated silane precursors (Si(ph)ₙX₍₄₋ₙ₎) available for selective reaction with sulfuric acid. When n=1, a monoprotic acid is obtained due to the favorable leaving kinetics of the phenyl group in the following acid-producing reaction (Equation 2):

Si(ph)ₙX₍₄₋ₙ₎+H₂SO₄→SiX₍₄₋ₙ₎(SO₄H)ₙ+nC₆H₆ (2)

An example of a plastic crystal electrolyte of the above type (i.e., SiX₃SO₄Li) that is particularly well-suited for making first plastic crystal electrolyte interlayer 19 and second plastic crystal electrolyte interlayer 21 may be lithium trimethylsilylsulfate.

Other types of plastic crystal electrolytes that may be used to form first plastic crystal electrolyte interlayer 19 and second plastic crystal electrolyte interlayer 21 may be members of the following three groups of compounds known to exhibit plastic crystal behavior: (i) inorganic salts, such as Li₂SO₄, which can demonstrate plastic crystal behavior at high temperatures (see Pringle, “Recent progress in the development and use of organic ionic plastic crystal electrolytes,” Physical Chemistry Chemical Physics, 15:1339-1351 (2013), which is incorporated herein by reference); (ii) molecular species, such as succinonitrile, which can allow good ionic conductivity by the addition of a lithium salt (see Timmermans, “Plastic crystals: a historical review,” Journal of Physics and Chemistry of Solids, 18:1-8 (1961); and Sherwood, The Plastically Crystalline State: Orientationally Disordered Crystals, John Wiley & Sons (1979), both of which are incorporated herein by reference); and (iii) organic ionic plastic crystals, which utilize a relatively large and symmetrical organic cation in combination with an inorganic anion that is normally either symmetrical or has a diffuse charge (see MacFarlane et al., “Plastic Crystal Electrolyte Materials: New Perspectives on Solid State Ionics,” Advanced Materials, 13:957-966 (2001); and MacFarlane et al., “Lithium-doped plastic crystal electrolytes exhibiting fast ion conduction for secondary batteries,” Nature, 402:792-794 (1999), both of which are incorporated herein by reference). The organic plastic crystal electrolyte materials can be in their most conductive, plastic phase around ambient temperature, hence their appeal as solid state electrolytes. Examples of materials that may be combined with lithium salt to make organic plastic crystal electrolytes include, but are not limited to, the following: pyrrolidinium; tetramethylammonium; imidazaolium; alkyl sulfoniums; 1-ethyl-1,4-diazabicyclo[2.2.2]octane; alkylene bis[N—(N′-alkylimidazolium)] salts; bis(fluorosulfonyl)amide; cyanate; choline; dihydrogen phosphate; dicyanomethanide; Li[B(OCH 2 CH 2 OCH 3) 4]; dicyanamide; and bis(trifluoromethyl sulfonyl)amide. Additional plastic crystal electrolytes are disclosed in Kamaya et al., “A lithium superionic conductor,” Nature Materials, 10:682-686 (2011), which is incorporated herein by reference.

Plastic crystal electrolyte interlayer 19 and 21 may be fabricated according to a number of different techniques including, but not limited to, the following: (1) tape-casting (i.e., blade-casting); (2) hot-pressing; and (3) melt-infusion.

The above-noted tape-casting technique may comprise using a blade with a constant gap to apply a layer of plastic crystal electrolyte having a thickness of about 1-100 μm to one or both of the electrodes (i.e., anode 13 and cathode 15) or to one or both opposing faces 23 and 25 of solid-state electrolyte membrane 17.

The above-noted hot-pressing technique may comprise the following three steps: (1) interposing a solid-state electrolyte and a plastic crystal electrolyte between two metal plates; (2) then, pressurizing and heating the two metal plates for a specified time; and (3) then, removing the solid-state electrolyte/plastic crystal electrolyte composite material after it has cooled to a desired temperature. Each step of the aforementioned hot-pressing technique may be performed in an inert atmosphere (e.g., dry room, argon-purged glove box, etc.).

The above-noted melt-infusion technique may comprise the following three steps: (1) interposing a solid-state electrolyte and a plastic crystal electrolyte between two metal plates; (2) then, heating the two metal plates until the plastic crystal electrolyte liquefies and penetrates the pores of the solid-state electrolyte, and (3) then, removing the solid-state electrolyte/plastic crystal electrolyte composite material after it has cooled to a desired temperature. Each step of the aforementioned melt-infusion technique may be performed in an inert atmosphere (e.g. dry room, argon-purged glove box, etc.).

Some additional comments, features, aspects and/or observations relating to one or more embodiments of the present invention are provided below.
The use of a plastic crystal electrolyte in accordance with the present invention may reduce the interfacial resistance between the cathode and the solid-state electrolyte membrane and/or between the anode and the solid-state electrolyte membrane.
By reducing interfacial resistance between the cathode and the solid-state electrolyte membrane and/or between the anode and the solid-state electrolyte membrane, the use of a plastic crystal electrolyte may enable room temperature cycling of the solid-state electrolyte membrane.
The high resistance at the solid-state electrolyte membrane/electrode interface is a challenge for the application of solid-state electrolytes. A plastic crystal electrolyte with good wetting not only may provide an evenly distributed lithium ion flux at the interface but also may prevent potential reduction of the solid-state electrolyte membrane in contact with a lithium metal anode. In accordance with the present invention, a plastic crystal electrolyte layer may provide a conformal coating to the solid-state electrolyte membrane, which can compensate for the interfacial roughness and enable a homogeneous lithium ion flux through the interface. The thickness of the plastic crystal electrolyte interlayer may be between ˜100 nm and 500 μm to achieve the lowest possible resistance at the solid-state electrolyte membrane/plastic crystal electrolyte interface.
By supporting a solid electrolyte into a porous polymer film, a flexible, robust membrane can be inexpensively fabricated. The thickness of the membrane (100 nm-100 μm) may dictate the electrolyte thickness, and the conductivity of the electrolyte may be retained despite using the membrane with no penalty paid for the improvements in fabrication and handling ability.
There are various advantages to the use of plastic crystal electrolytes in accordance with the present invention. First, the plastic crystals are pliable, reducing the problem of establishing and maintaining good contact with electrodes in case of volume changes at the electrode/electrolyte interface. A second potential advantage is that, even after plastic crystal transition where the orientational order becomes arrested, the plastic crystals retain their solidity (finite shear modulus) at elevated temperatures. In principle, this opens the door to higher solid-state conductivities than have been attained with superionic plastic crystals. A third advantage is the high Li-ion conductivity (>10 mS/cm) and transfer number (single ion conductor) associated with the plastic crystal electrolytes.

The following examples are given for illustrative purposes only and are not meant to be a limitation on the invention described herein or on the claims appended hereto.

### Example 1— Cyclic Voltammetry (CV) Measurements

Cyclic voltammetry (CV) measurements were performed using a VERSASTAT potentiostat (Ametek, Inc., Berwyn, PA) at a rate of 0.1 m V/s. FIG. 5A depicts the results from a Li/Li⁺ symmetrical cell plating on a solid electrolyte membrane with plastic crystal electrolyte coated on one side of the solid electrolyte membrane.

The overpotential of the side coated with a plastic crystal electrolyte was less (0.1V) than the side without a plastic crystal electrolyte coating (0.42V). Symmetrical cells were prepared using lithium metal as both the working electrode and the counter electrolyte and with a solid electrolyte membrane having plastic crystal electrolyte coated on one side as the separator. The results from FIG. 5A indicate that the overpotential for lithium plating reduces in the side facing the electrode. This is believed to be due to the reduction in interface resistance attributable to the presence of the plastic crystal electrolyte.

FIG. 5B depicts the results from the full cell CV on a solid electrolyte membrane having plastic crystal electrolyte layers on both sides of the solid electrolyte membrane. Full cells were assembled in 2032-coin cells with a lithium anode, a lithium nickel manganese cobalt oxides (NMC) cathode (7.5 mg/cm² loading), and a solid electrolyte membrane coated with plastic crystal electrolyte on both sides of the membrane. The CV from FIG. 5B shows a peak at 3.08 V corresponding to the de-lithiation reaction. The presence of this peak supports the premise that the plastic crystal electrolyte layers reduce interface resistance and help in cell cycling.

### Example 2—Full Cell Cycling Measurements

Full cell cycling measurements were performed in 2032-coin cells at room temperature. The 2032-coin cells were assembled in an argon-filled glove box using lithium metal anodes, NMC 811 (80% Ni, 10% Mn, 10% Co) cathodes, and solid-state electrolyte membranes. The galvanostatic charge-discharge cycling experiments were performed between 2.4-4.2 V using a MACCOR cycling station (Maccor, Inc., Tulsa, OK)

FIGS. 6A and 6B depict the results of the charge-discharge experiments on the solid-state electrolyte membranes with and without plastic crystal electrolyte, respectively, at room temperature. The cells were cycled at C/20 at room temperature without applying any external pressure.

When cycled, the cell without the plastic crystal electrolyte exhibited an initial capacity of 93 mAh/g-NMC at C/20 rate, which quickly faded 10 mAh/g-NMC at cycle 18. By contrast, the cell with the plastic crystal electrolyte interlayer positioned between the electrode and the solid-state electrolyte exhibited an initial capacity of 181 mAh/g-NMC at 120 mAh/g at cycle 18. The improvement in capacity upon addition of plastic crystal electrolyte interlayer is believed to be due to the reduction of electrode/solid-state electrolyte interface resistance.

As seen in FIG. 7A, the cell with the plastic crystal electroltye interlayer exhibited good cycling performance at different C-rates (C/20, C/10 and C/5) when tested with an NMC cathode at 1 mg-NMC/cm² loading. As seen in FIG. 7B, such a cell cycled well at NMC loadings as high as 10 mg-NMC/cm², with <30% loss in capacity when cycled at C/10 rate. It is important to note that all of these cycling tests were performed in the absence of any external pressure.

The embodiments of the present invention described above are intended to be merely exemplary and those skilled in the art shall be able to make numerous variations and modifications to it without departing from the spirit of the present invention. All such variations and modifications are intended to be within the scope of the present invention.

What is claimed is:

1. A solid-state electrolyte battery, the solid-state electrolyte battery comprising:
(a) an anode;
(b) a cathode;
(c) a solid-state electrolyte membrane, the solid-state electrolyte membrane positioned between and operatively coupled to the anode and the cathode, wherein the solid-state electrolyte membrane is spaced away from at least one of the anode and the cathode; and
(d) a first plastic crystal electrolyte interlayer, at least a portion of the first plastic crystal electrolyte interlayer being positioned between the solid-state electrolyte membrane and one of the anode and the cathode.

2. The solid-state electrolyte battery as claimed in claim 1 wherein the solid-state electrolyte membrane is spaced away from each of the anode and the cathode and wherein at least a portion of the first plastic crystal electrolyte interlayer is positioned between the solid-state electrolyte membrane and the anode, the solid-state electrolyte battery further comprising a second plastic crystal electrolyte interlayer, wherein at least a portion of the second plastic crystal electrolyte interlayer is positioned between the solid-state electrolyte membrane and the cathode.

3. The solid-state electrolyte battery as claimed in claim 2 wherein the first plastic crystal electrolyte interlayer is in direct contact with each of the anode and the solid-state electrolyte membrane and wherein the second plastic crystal electrolyte interlayer is in direct contact with each of the cathode and the solid-state electrolyte membrane.

4. The solid-state electrolyte battery as claimed in claim 3 wherein each of the first plastic crystal electrolyte interlayer and the second plastic crystal electrolyte interlayer has a thickness in a range of about 100 nm to about 100 microns.

5. The solid-state electrolyte battery as claimed in claim 4 wherein the solid-state electrolyte membrane has a thickness in a range of about 100 microns to about 1 millimeter.

6. The solid-state electrolyte battery as claimed in claim 1 wherein the solid-state electrolyte membrane comprises a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight.

7. The solid-state electrolyte battery as claimed in claim 6 wherein the solid-state electrolyte membrane comprises a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

8. The solid-state electrolyte battery as claimed in claim 1 wherein the first plastic crystal electrolyte interlayer comprises a plastic crystal electrolyte of the formula SiX₃SO₄Li wherein X is a hydrocarbon moiety.

9. The solid-state electrolyte battery as claimed in claim 8 wherein the first plastic crystal electrolyte interlayer comprises lithium trimethylsilylsulfate.

10. The solid-state electrolyte battery as claimed in claim 1 wherein the first plastic crystal electrolyte interlayer comprises an inorganic salt that demonstrates plastic crystal behavior at high temperatures.

11. The solid-state electrolyte battery as claimed in claim 10 wherein the inorganic salt is Li₂SO₄.

12. The solid-state electrolyte battery as claimed in claim 1 wherein the first plastic crystal electrolyte interlayer comprises a molecular species that allows good ionic conductivity by the addition of a lithium salt.

13. The solid-state electrolyte battery as claimed in claim 12 wherein the molecular species is succinonitrile.

14. The solid-state electrolyte battery as claimed in claim 1 wherein the first plastic crystal electrolyte interlayer comprises an organic ionic plastic crystal.

15. The solid-state electrolyte battery as claimed in claim 14 wherein the organic ionic plastic crystal is at least one member of the group of pyrrolidinium; tetramethylammonium; imidazaolium; alkyl sulfoniums; 1-ethyl-1,4-diazabicyclo[2.2.2]octane; alkylene bis[N—(N′-alkylimidazolium)] salts; bis(fluorosulfonyl)amide; cyanate; choline; dihydrogen phosphate; dicyanomethanide; Li[B(OCH 2 CH 2 OCH 3) 4]; dicyanamide; and bis(trifluoromethyl sulfonyl)amide.

16. The solid-state electrolyte battery as claimed in claim 3 wherein each of the first plastic crystal electrolyte interlayer and the second plastic crystal electrolyte interlayer has a thickness in a range of about 100 nm to about 100 microns, wherein the solid-state electrolyte membrane has a thickness in a range of about 100 microns to about 1 millimeter, wherein the solid-state electrolyte membrane comprises a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight, and wherein each of the first plastic crystal electrolyte interlayer and the second plastic crystal electrolyte interlayer comprises lithium trimethylsilylsulfate.

17. The solid-state electrolyte battery as claimed in claim 16 wherein the solid-state electrolyte membrane comprises a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

18. A solid-state electrolyte battery, the solid-state electrolyte battery comprising:
(a) an anode;
(b) a cathode;
(c) a solid-state electrolyte membrane, the solid-state electrolyte membrane positioned between and operatively coupled to the anode and the cathode, the solid-state electrolyte membrane having first and second opposed surfaces;
(d) a first plastic crystal electrolyte, the first plastic crystal electrolyte being disposed at at least one of the first and second opposed surfaces of the solid-state electrolyte membrane.

19. The solid-state electrolyte battery as claimed in claim 18 wherein the first plastic crystal electrolyte is disposed at the first opposed surface of the solid-state electrolyte membrane, the solid-state electrolyte battery further comprising a second plastic crystal electrolyte, wherein at least a portion of the second plastic crystal electrolyte is disposed at the second opposed surface of the solid-state electrolyte membrane.

20. The solid-state electrolyte battery as claimed in claim 19 wherein the first plastic crystal electrolyte is in direct contact with each of the anode and the solid-state electrolyte membrane and wherein the second plastic crystal electrolyte is in direct contact with each of the cathode and the solid-state electrolyte membrane.

21. The solid-state electrolyte battery as claimed in claim 20 wherein each of the first plastic crystal electrolyte and the second plastic crystal electrolyte has a thickness in a range of about 100 nm to about 100 microns.

22. The solid-state electrolyte battery as claimed in claim 21 wherein the solid-state electrolyte membrane has a thickness in a range of about 100 microns to about 1 millimeter.

23. The solid-state electrolyte battery as claimed in claim 22 wherein the solid-state electrolyte membrane comprises a mixture of polyethylene oxide in an amount constituting 50-90% by weight, lithium lanthanum zirconium oxide in an amount constituting 10-40% by weight, and lithium trifluoromethane sulfonimide in an amount constituting 10-40% by weight.

24. The solid-state electrolyte battery as claimed in claim 23 wherein the solid-state electrolyte membrane comprises a mixture of polyethylene oxide in an amount constituting about 65% by weight, lithium lanthanum zirconium oxide in an amount constituting about 20% by weight, and lithium trifluoromethane sulfonimide in an amount constituting about 15% by weight.

25. The solid-state electrolyte battery as claimed in claim 24 wherein the first plastic crystal electrolyte interlayer comprises a plastic crystal electrolyte of the formula SiX₃SO₄Li wherein X is a hydrocarbon moiety.

26. The solid-state electrolyte battery as claimed in claim 25 wherein the first plastic crystal electrolyte interlayer comprises lithium trimethylsilylsulfate.

27. A solid-state electrolyte membrane suitable for use in a solid-state electrolyte battery, the solid-state electrolyte membrane comprising a mixture of:
(a) polyethylene oxide in an amount constituting 50-90% by weight;
(b) lithium lanthanum zirconium oxide in an amount constituting 10-40% by weight; and
(c) lithium trifluoromethane sulfonimide in an amount constituting 10-40% by weight.

28. The solid-state electrolyte membrane as claimed in claim 27 wherein the polyethylene oxide constitutes about 65% by weight, the lithium lanthanum zirconium oxide constitutes about 20% by weight, and the lithium trifluoromethane sulfonimide constitutes about 15% by weight.

29. A solid-state electrolyte battery, the solid-state electrolyte battery comprising:
(a) an anode;
(b) a cathode;
(c) the solid-state electrolyte membrane as claimed in claim 27, the solid-state electrolyte membrane positioned between and operatively coupled to the anode and the cathode.

30. The solid-state electrolyte battery as claimed in claim 29 further comprising a first plastic crystal electrolyte interlayer interfacing the solid-state electrolyte and the anode and a second plastic crystal electrolyte interlayer interfacing the solid-state electrolyte and the cathode.

31. The solid-state electrolyte battery as claimed in claim 30 wherein each of the first plastic crystal electrolyte interlayer and the second plastic crystal electrolyte interlayer comprises lithium trimethylsilylsulfate.

32. The solid-state electrolyte battery as claimed in claim 30 wherein the anode is a lithium metal anode and wherein the cathode is a lithium nickel manganese cobalt oxide cathode.

33. The solid-state electrolyte battery as claimed in claim 30 wherein each of the first plastic crystal electrolyte and the second plastic crystal electrolyte has a thickness in a range of about 100 nm to about 100 microns and wherein the solid-state electrolyte membrane has a thickness in a range of about 100 microns to about 1 millimeter.
